(19) United States
(12) Patent Application Publication
(10) Pub. No.: US 2009/0164063 A1
(43) Pub. Date: Jun. 25, 2009

(54) VEHICLE-MOUNTED TOOL FOR MONITORING ROAD SURFACE DEFECTS

(75) Inventors: Sandro Piccinini, Rome (IT); Luigi Pichetti, Rome (IT); Marco Secchi, Rome (IT); Antonio Secomandi, Brugherio (IT); Amr Yassin, Cairo (EG); Mohamed Zakaria, Cairo (EG)

Correspondence Address: IBM CORP. (AUSTIN), C/O NELSON AND NELSON, 2984 E. EVERGREEN AVE., SALT LAKE CITY, UT, 84109, US

(73) Assignee: International Business Machines Corporation, Armonk, NY (US)

(21) Appl. No.: 12/337,250

(22) Filed: Dec. 17, 2008

(30) Foreign Application Priority Data
Dec. 20, 2007 (EP) EP07123769

(51) Int. Cl. B60W 10/00; B60W 10/20; B60W 10/22

(52) U.S. Cl. 701/37; 701/207; 701/213; 701/45

(57) ABSTRACT

A vehicle-mountable system is provided for monitoring road surface defects. The system may include a detector to detect a surface defect in a road surface along which a vehicle is traveling. A positioning system may determine an instant location of the vehicle, and a repository may store a location of the surface defect with reference to the instant location. A controller unit may receive and compare the instant location with the location of the surface defect to identify an imminent surface defect encounter. The controller unit may also identify guidance instructions to minimize an effect of the imminent surface defect encounter. Finally, an interface may relay the guidance instructions to the vehicle.

### BACKGROUND OF THE INVENTION

Navigation systems have become increasingly popular in recent years. Typical navigation systems include a small electronic device that provides information that facilitates a driver's ability to reach a desired destination. Generally, navigation systems operate by detecting where the navigation unit is positioned (using Global Positioning Satellites (“GPS”)), and by applying that position to a context, using a map and the desired destination, for example. Based on this information, the navigation system may suggest how the driver should navigate the vehicle (e.g., turn right in 500 meters) to get to the desired destination. The navigation system may also suggest possible route alternatives based on the map and personal preferences (e.g., avoiding motorways), and may provide additional information such as broadcasts of traffic information (e.g., traffic jams on certain routes).

While this information is often helpful, known navigation systems are not equipped to inform a driver of hazardous and other unsafe road conditions such as damaged pavement, road obstructions, and debris, which might compromise an otherwise desirable route of travel. Indeed, such conditions may damage a vehicle, and may pose a danger for passengers contained therein.

### SUMMARY

Embodiments of the invention have been developed to monitor road surface defects and enable drivers to avoid such defects.

In one embodiment of the present invention, a vehicle-mountable system is provided for monitoring road surface defects. The system may include a detector to detect a surface defect in a road surface along which a vehicle is traveling. A positioning system may determine an instant location of the vehicle, and a repository may store a location of the surface defect with reference to the instant location. A controller unit may receive and compare the instant location with the location of the surface defect to identify an imminent surface defect encounter. The controller unit may also identify guidance instructions to minimize an effect of the imminent surface defect encounter. Finally, an interface may relay the guidance instructions to the vehicle.

A corresponding method and computer program product are also disclosed and claimed herein.

### BRIEF DESCRIPTION OF THE DRAWINGS

In order that the advantages of the disclosure will be readily understood, a more particular description of embodiments of the invention briefly described above will be rendered by reference to specific embodiments illustrated in the appended drawings. Understanding that these drawings depict only typical embodiments of the invention and are not therefore to be considered limiting of its scope, embodiments of the invention will be described and explained with additional specificity and detail through use of the accompanying drawings, in which:

FIG. 1 is a schematic block diagram of a system in accordance with embodiments of the invention;

FIG. 2 depicts functional blocks of a generic computer system;

FIG. 3 illustrates a system suitable for implementing embodiments of the present invention;

FIG. 4 is a diagram illustrating the flow of activities relating to one embodiment of the invention; and

FIG. 5 depicts an alternative embodiment of the present invention.

### DETAILED DESCRIPTION OF THE INVENTION

It will be readily understood that the components of embodiments of the present invention, as generally described and illustrated in the Figures herein, may be arranged and designed in a wide variety of different configurations. Thus, the following more detailed description of the embodiments of the systems and methods of the present invention, as represented in the Figures, is not intended to limit the scope of the disclosure, as claimed, but is merely representative of selected embodiments of the invention.

Reference throughout this specification to “one embodiment,” “an embodiment,” or similar language means that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that embodiments of the invention can be practiced without one or more of the specific details, or with other methods, components, etc. In other instances, well-known structures, or operations are not shown or described in detail to avoid obscuring aspects of the disclosure.

The illustrated embodiments of the invention will be best understood by reference to the drawings, wherein like parts are designated by like numerals throughout. The following description is intended only by way of example, and simply illustrates certain selected embodiments of the invention that are consistent with the disclosure as claimed herein.

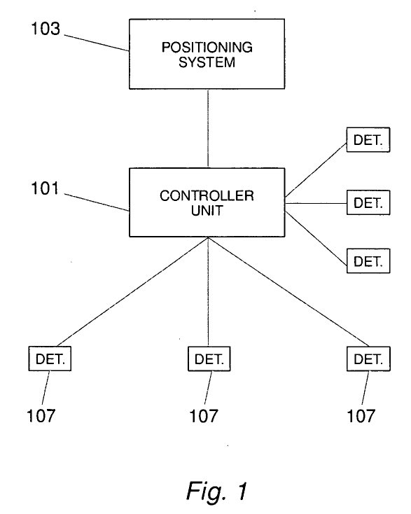

With reference now to FIG. 1, a vehicle-mounted system 100 in accordance with one embodiment of the present invention is depicted. The system 100 may include a controller unit 101 connected to a positioning system 103 (e.g., a GPS satellite receiver) and to one or more detectors 107. The controller unit 101 may be a mobile computer unit, vehicle unit, or more generally any kind of data processing system capable of receiving and processing data. The detectors 107, together with the positioning system 103, may identify road surface defects. This data may be collected and stored for later use by the controller unit 101.

The detectors 107 may operate, for example, by means of bump sensors that may also provide information on the size and the depth of the bump based on the detected shock with respect to the vehicle speed. It is noted that these kinds of shock detectors (i.e., bump sensors) may be found on cars to adjust the active suspension system of the car. According to one embodiment of the present invention, such information may be stored in a local repository or database. Other solutions, however, may include transmitting the information to a server equipped to collect, process and transmit such information to a plurality of connected endpoints (e.g., a plurality of subscribed satellite receivers).

The controller unit 101, with the assistance of the positioning system 103 may monitor the position of the vehicle and, when the position of one of the identified road surface defects is approaching, may take the necessary actions to minimize the effect of such defects to the vehicle and its passengers.

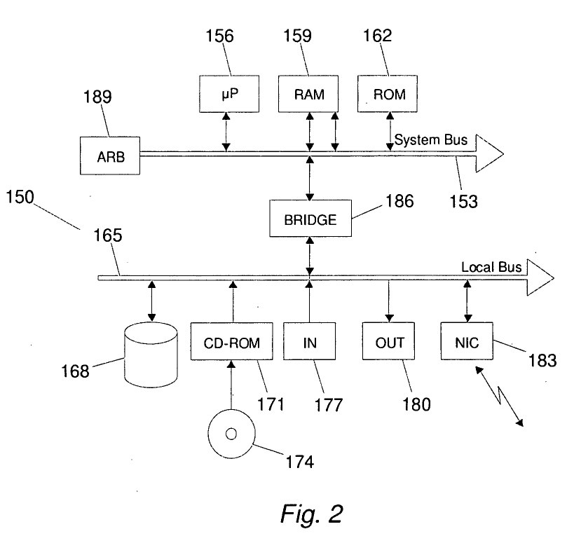

Referring now to FIG. 2, a generic computer of a system in accordance with the present invention (e.g., a mobile computer unit, central server, router, and transmitter) is denoted with 150. The computer 150 may be formed by several units that are connected in parallel to a system bus 153.

In detail, one or more microprocessors (μP) 156 may control operation of the computer 150. A RAM 159 may be directly used as a working memory by the microprocessors 156, and a ROM 162 may store basic code for a bootstrap of the computer 150. Peripheral units may be clustered around a local bus 165 by means of respective interfaces. Particularly, a mass memory may consist of a hard-disk 168 and a drive 171 for reading CD-ROMs 174. Moreover, the computer 150 may include input devices 177 (for example, a keyboard and a mouse), and output devices 180 (for example, a monitor and a printer). A Network Interface Card (“NIC”) 183 may be used to connect the computer 150 to the network. A bridge unit 186 may provide an interface between the system bus 153 and the local bus 165. Each microprocessor 156 and the bridge unit 186 may operate as master agents requesting an access to the system bus 153 for transmitting information. An arbiter 189 may manage granting access with mutual exclusion to the system bus 153.

Similar considerations may apply if the system has a different topology, or is based on other networks. Alternatively, the computers may have a different structure, include equivalent units, or consist of other data processing entities (such as PDAs, mobile phones, and the like). In any case, embodiments of the invention may also be suitable to be used in a system where the control of the workstations is decentralized, or even in a stand-alone computer, such as an in-vehicle satellite navigation system.

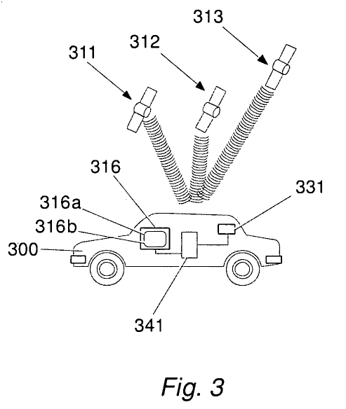

FIG. 3 shows a system suitable for implementing an embodiment of the present invention. As shown in FIG. 3, a constellation of navigation satellites 311,312 and 313 may belong, for example, to the GPS or Galileo system. A vehicle 300 may carry a navigation system 316. The navigation system may include a mobile computer unit 316a, including a sensor interface 316b and a satellite positioning receiver 331. The sensor interface 316b may receive input from, for example, the shock detectors and other sensors embedded in the vehicle 300. The satellite positioning receiver 331 may receive timing data transmitted by the navigation satellites 311, 312 and 313, and thereby determine the instantaneous position of the vehicle 300.

During operation, a sensor in the vehicle 300 may detect a bump and transmit this information to the vehicle's computer unit 316a. The satellite positioning receiver 331 may process signals received from the navigation satellites 311, 312 and 313 so as to determine the position of the vehicle 300. This information may be later used by the vehicle when it is again in proximity to the determined position. In some embodiments, the system may include a database 341 where all the detected road surface defects have been recorded together with the corresponding location. Accordingly, when the vehicle approaches a position recorded in the database 341, as monitored by the satellite positioning receiver 331, the driver of the vehicle may be alerted of the impending road defect. Alternatively or additionally, corrective actions may be implemented by the vehicle controller system, as described in more detail below.

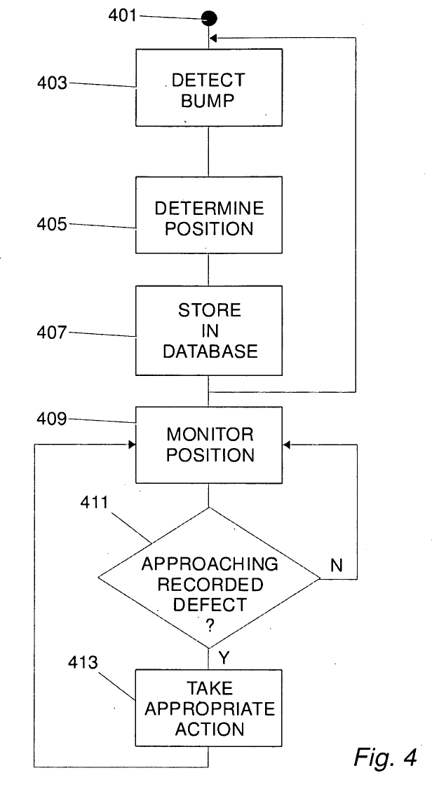

With reference now to FIG. 4, a method for monitoring a road surface in accordance with an embodiment of the invention is illustrated with a diagram. The method may begin at the black start circle 401. Continuing to block 403, a sensor 107 (see FIG. 1) may detect the bump. As explained above, this detection may be performed in any of several ways, including by using a shock sensor mounted on the vehicle. The system may then determine the position of the bump by means of a GPS satellite receiver of the vehicle, for example (step 405). The combined information (i.e. the position and the nature of the defect) may be stored in the vehicle database for future use (step 407).

In a further embodiment of the present invention, the information may be transmitted to a central controller, so that other road users may be alerted of the presence of the identified road surface defects. This transmission may be done immediately by means of a mobile telephone line such as GSM network, for example, or alternatively may be collected within the endpoint and transferred later. The central controller may put together all information received to build a map of possible bumps or road roughness.

The position of the vehicle may be substantially constantly monitored by the positioning system (step 409) such that when the vehicle approaches one of the previously-identified positions stored on the vehicle database (step 411), an appropriate action may be taken at step 413. The range of appropriate actions may be considerable, going from simply advising the users, to planning road maintenance actions, or even to applying some corrective measures for vehicle equipment to respond to the detected road conditions. The thresholds for labeling a condition “severe” may be adjusted as desired.

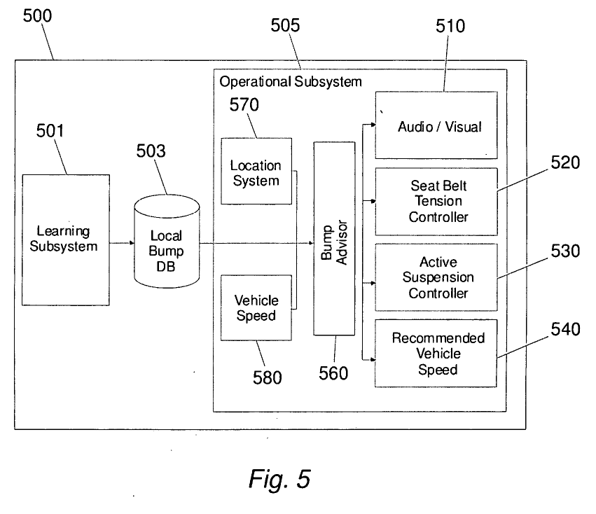

FIG. 5 represents a further embodiment of the present invention. In this embodiment, the system 500 may include the learning subsystem 501, which basically corresponds to the system described above for collecting information about bumps on the road, and more generally information about road conditions. The learning subsystem 501 may be responsible for storing and updating data relating to road conditions, locations of detected bumps, bump characteristics (e.g. width, length), other available lanes, road type (e.g., paved, unpaved, gravel road), and the like.

Such information may be stored on the alert database 503 within the vehicle. The database 503 may provide the necessary information to the operational subsystem 505, which may exploit the road condition information to adjust one or more settings in the vehicle equipment. The operational subsystem 505 may also include a system 570 that provides information on the current location of the vehicle (e.g., a GPS navigator), and a speed meter 580.

The bump advisor component 560 may provide the core processing unit of the operational subsystem 505. In certain embodiments, it receives input from the local bump database 503, the location system 570, and the vehicle speed meter 580. All inputs may be analyzed and processed to provide the necessary control input to a series of equipment including, for example, a seat belt tension controller 520, an active suspension controller 530, and a recommended vehicle speed controller 540. The seat belt tension controller 520 may adjust the tension of seat belts if the road is severely damaged. The active suspension controller 530 may find the best set up of the suspension system according to the road surface, and the recommended vehicle speed controller 540 may limit the maximum speed in case of difficult road conditions. An audio/visual interface 510 may be used to communicate information to the driver. Those skilled in the art, however, will appreciate that the above examples are only a selection of possible uses and implementations of the present invention.

One advantage of embodiments of the present invention is that existing structures may be used to implement the invention without the need for a dedicated, complex and expensive infrastructure. Particularly, these existing structures may be exploited to implement a monitoring system able to detect road surface defects and help the driver of a vehicle respond in an appropriate manner.

1. A vehicle-mountable system for monitoring road surface defects, the system comprising:
a detector for detecting a surface defect in a road surface along which a vehicle is traveling;
a positioning system for determining an instant location of the vehicle;
a repository for storing a location of the surface defect with reference to the instant location;
a controller unit to receive and compare an instant location of the vehicle with the location of the surface defect to identify an imminent surface defect encounter, wherein the controller unit further determines guidance instructions to minimize an effect of the imminent surface defect encounter; and
an interface to relay the guidance instructions to the vehicle.

2. The system of claim 1, wherein the positioning system comprises a satellite-based positioning system.

3. The system of claim 1, wherein the interface further controls vehicle seatbelt tension as a function of the guidance instructions.

4. The system of claim 1, wherein the interface further controls vehicle suspension parameters as a function of the guidance instructions.

5. The system of claim 1, wherein the interface further generates signals intelligible to a driver of the vehicle.

6. The system of claim 5, wherein the signals intelligible to a driver of the vehicle comprise at least one of steering instructions and speed instructions.

7. The system of claim 1, wherein the detector further comprises a shock sensor for detecting and measuring an intensity of bumps on the road surface during vehicle travel.

8. The system of claim 7, wherein the repository further stores information relating to an intensity of a detected bump.

9. A method for monitoring road surface defects, the method comprising:
detecting a surface defect in a road surface along which a vehicle is traveling;
determining an instant location of the vehicle; and
storing the location of the detected surface defect with reference to the instant location.

10. The method of claim 9, further comprising:
monitoring an instant location of the vehicle;
comparing the instant location with the stored location of the detected surface defect to identify an imminent surface defect encounter;
identifying guidance instructions to minimize an effect of the imminent surface defect encounter; and
relaying the guidance instructions to the vehicle.

11. The method of claim 9, wherein determining the instant location comprises utilizing a satellite-based positioning system to determine the instant location.

12. The method of claim 10, wherein relaying the guidance instructions further comprises controlling vehicle seatbelt tension as a function of the guidance instructions.

13. The method of claim 10, wherein relaying the guidance instructions further comprises controlling vehicle suspension parameters as a function of the guidance instructions.

14. The method of claim 10, wherein relaying the guidance instructions further comprises generating signals intelligible to a driver of the vehicle.

15. The method of claim 14, wherein the signals intelligible to a driver of the vehicle comprise at least one of steering instructions and speed instructions.

16. A computer program product for monitoring road surface defects, the computer program product comprising:
a computer-usable medium having computer-usable program code embodied therein, the computer-usable program code comprising:
computer-usable program code for detecting a surface defect in a road surface along which a vehicle is traveling;
computer-usable program code for determining an instant location of the vehicle;
computer-usable program code for storing the location of the detected surface defect with reference to the instant location;
computer-usable program code for monitoring an instant location of the vehicle;
computer-usable program code for comparing the instant location with the stored location of the detected surface defect to identify an imminent surface defect encounter;
computer-usable program code for identifying guidance instructions to minimize an effect of the imminent surface defect encounter; and
computer-usable program code for relaying the guidance instructions to the vehicle.

17. The computer program product of claim 16, wherein the computer-usable program code for determining the instant location further comprises computer-usable program code for utilizing a satellite-based positioning system to determine the instant location.

18. The computer program product of claim 16, wherein the computer-usable program code for relaying the guidance instructions further comprises computer-usable program code for controlling vehicle seatbelt tension as a function of the guidance instructions.

19. The computer program product of claim 16, wherein the computer-usable program code for relaying the guidance instructions further comprises computer-usable program code for controlling vehicle suspension parameters as a function of the guidance instructions.

20. The computer program product of claim 16, wherein the computer-usable program code for relaying the guidance instructions further comprises computer-usable program code for generating signals intelligible to a driver of the vehicle.
